(19) United States
(12) Patent Application Publication
(10) Pub. No.: US 2008/0074575 A1
(43) Pub. Date: Mar. 27, 2008

(54) Liquid Crystal Display Device

(76) Inventors: Wolfram Wiemer, Blaustein (DE); Arno Bohm, Mannheim (DE)

Correspondence Address: John E Munger;Jansson Shupe Munger & Antaramian, 245 Main Street, Racine, WI, 53403, US

(21) Appl. No.: 11/597,645

(22) PCT Filed: Nov. 8, 2005
(86) PCT No.: PCT/EP05/11939

§ 371 Date: Nov. 27, 2006

(30) Foreign Application Priority Data
Nov. 9, 2004 (DE) 20 2004 017 411.1
Oct. 19, 2005 (DE) 20 2005 016 373.2

(51) Int. Cl. G02F 1/1335; G02B 5/02; G02F 1/13

(52) U.S. Cl. 349/58; 349/112; 349/96; 428/1.3; 428/1.33

(57) ABSTRACT

The invention relates to a liquid crystal display comprising a multi-layered display unit (1) which is introduced into a housing (20). Said unit comprises, in a successive manner from the visible side to the rear side, a front polarisation filter (11), a liquid crystal layer (12), a rear polarisation filter (13) and a diffusion layer (14) or retro-reflection layer, optionally, with additional layers (15, 16). High luminosity is achieved by virtue of the fact that the diffusion layer or the retro-reflection layer are provided with fluorescent colours (14.1).

The invention refers to a liquid crystal display device with a multi-layered display unit mounted in a housing. The following layers are arranged from the viewing side to the rear side of the display unit: a front polarization filter, a liquid crystal layer, a rear polarization filter, and a diffusion layer or retro-reflection layer. Additional layers may be arranged in a successive manner in between the aforementioned layers.

This type of liquid crystal display is disclosed in WO 02/084 383 A. In this display device, as is customary, a display unit includes a substrate. Polarization filters cover the outer side of the substrate. The filter polarization directions are arranged perpendicularly to each other to provide a bright, voltage-free display. In addition, a liquid crystal cell layer rotated at an angle of <90° is utilized. The liquid crystal cell layer is advantageous for viewing the display because the display may be viewed straight on and at an angle.

An additional liquid crystal display device of this type is described in WO 00/14596. The liquid crystal display can be operated in a transmissive mode with rear light, a reflective mode with forward light, or in a combined transmissive/reflective mode. The liquid crystal display mode may be adjusted based on ambient lighting conditions.

In many situations with liquid crystal displays, the contrast or luminosity sufficient enough to enable trouble-free character or image recognizabilty is not achieved.

The invention solves the problem of providing a liquid crystal display device, which yields enhanced luminosity or contrast, respectively, with as little energy consumption as possible.

The characteristics in claim 1 solve this problem. In order to do this, it is intended that the diffusion layer or retro-reflection layer is provided with fluorescent dyes.

By use of fluorescent dyes in the diffusion layer or the diffusion screen, respectively, or retro-reflection layer or retro-reflection film, respectively, light incident in the emission wavelength of the fluorescent dye is emitted continuously with uniform distribution of the polarization direction. The result is that the light of the associated polarization direction is transmitted to the viewing side through the polarization filter preceding it.

The use of this voltage-free light type of liquid crystal layer promotes a particular luminosity or higher contrast, respectively. In this configuration light incident from the front onto the cell is transmitted with the least absorption.

Further contributing to the increase in luminosity is a rear-polarization filter that has a luminosity increasing design. Such luminosity increasing polarization filters are known as BEF polarization filters (brightness enhancing filters), e.g. reflective polarizers.

In one implementation of the display device, a backlight assembly may be provided behind the diffusion layer to provide a display device with increased luminosity, which consumes relatively little energy.

In another favorable implementation, the multi-layer display unit is mounted in a housing, which is translucent at least in its rear area.

The translucent housing enables ambient light from the front side as well as the rear side to effectively illuminate the display and enhance contrast, improving recognizability of images and characters on the display. If additional backlighting is installed for nighttime operation, it can be implemented at relatively low power because of the high luminosity of the display, thereby saving energy.

To the extent possible, ambient light is utilized for the illumination of the display, provided that the side areas of the housing, in addition to rear wall, are also translucent. For additional illumination in dark conditions, one or more light sources can be arranged advantageously in or on the rear wall and/or in or on the side areas of the housing.

With their associated characteristics, light-emitting diodes (LEDs) utilized as light sources contribute to a robust, long-lasting, and energy-saving performance.

The light sources are mounted on a translucent base. This facilitates the utilization of ambient light and uniform illumination.

The invention is explained in more detail by means of the implementation examples shown in the drawings.

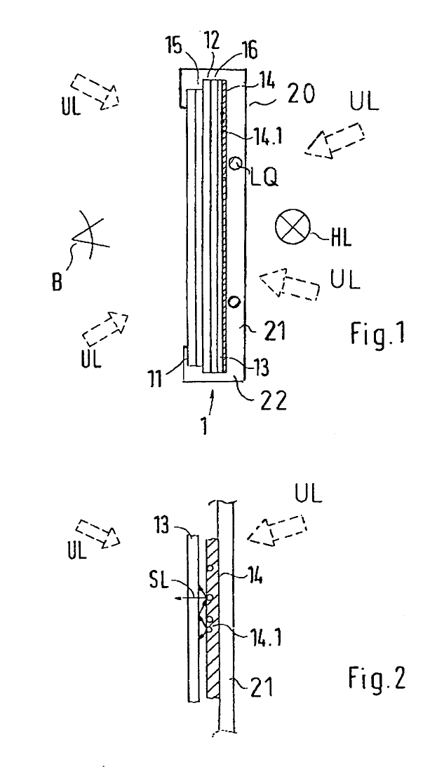

FIG. 1 a cross-section of the layer sequence of a liquid crystal display unit in schematic view and

FIG. 2 a section of the layer sequence in the rear area in accordance with FIG. 1.

FIG. 1 shows a liquid crystal display device with a display unit 1 mounted in a housing 20. Ambient light UL illuminates the layer sequence of the display unit 1 from the front side toward the rear, as determined by the viewer's B perspective, and/or backlight illuminates the sequence from the rear side HL forward. From the front side to the rear side, the layer sequence of the display unit 1 is comprised of a front polarization filter 11, a liquid crystal layer 12 with one or more liquid crystal cells, a rear polarization filter 13, and a diffusion layer or diffusion screen, respectively 14, or a retro-reflection layer or retro-reflection film, respectively. Furthermore, additional suitable layers 15, 16 can be arranged in the layer sequence. The publications mentioned in the introduction show further evidence of this. The additional layers 15, 16 can be arranged before and/or behind the liquid crystal layer 12 according to their respective functions. An advantageous design of the diffusion layer 14 or reflection layer is that it is provided with fluorescent dyes 14.1.

A standard film, as has been used until now in liquid crystal displays, is suitable as a front polarization filter 11. Light of one polarization direction is transmitted at a high percentage rate. Light from the perpendicularly aligned polarization direction is blocked or absorbed at a high percentage rate.

The TN type is used, for example, as the liquid crystal layer or liquid crystal cell, respectively 12. It is preferred because it has a construction that yields a voltage-free, bright display. With this mode of operation, incident light is transmitted from all directions from the front onto bright areas (uncontrolled areas) of the liquid crystal cell with the least amount of absorption. A particularly preferred implementation comprises a so-called LTN liquid crystal cell, as defined in WO 02/084 383 A, mentioned in the introduction.

The so-called BEF polarization filter (brightness enhancement filter), with its luminosity-increasing construction, is advantageously used as the rear polarization filter 13. In this type of filter, the light from the blocked polarization direction, which reaches the rear-polarizing filter 13 from the diffusion screen 14, is reflected back, for the most part, in the direction of the diffusion screen 14 or retro-reflection film. Light from one polarization direction is, in turn, transmitted from the light that continuously reaches the BEF filter 13. Radiation polarized in the orthogonal direction is continuously reflected towards the diffusion screen 14. If light incident onto the diffusion screen 14 changes its polarization direction, then a portion of the reflected light can ultimately pass through the liquid crystal cell 12. This increases the luminosity of the liquid crystal cell. This not only applies to light incident as background light HL but also to light incident from the direction of the observer B onto the display unit 1. This light can pass in the luminous areas of the liquid crystal cell 12 and is then thrown back or emitted from the diffusion screen 14 continuously in the direction of the liquid crystal cell 12. A reflective, not diffuse, polarization filter film is used as the luminosity increasing, rear polarization filter 13, especially in conjunction with the retro-reflection film or retro-reflection layer, respectively, because the scattering takes place in the light converter and in the fluorescent dye of the retro-reflection film or retro-reflection layer, respectively. This effect is used largely for the recycling of the reflected, polarized radiation. Prism structures, especially micro-prisms, and/or a diffusion indicatrix (index ellipsoid) that suits specific applications, can also be provided in the area of the diffusion layer 15 or retro-reflection layer. This provision contributes to an increase in luminosity or contrast, respectively, and also produces the desired viewing angle relative to the surface normal of the display (direction and/or f-ratio). Additionally the diffusion layer 15 or retro-reflection layer or film, respectively, can be configured to be wavelength selective, in order to achieve color properties.

FIGS. 1 and 2 show the housing, a translucent rear wall 21 as well as a border strip 22 that laterally surrounds the display unit. This border strip can also be made partly or completely translucent. Glass or plastic are suitable translucent materials because the materials are clear or cloudy and, if desired; may also be tinted. In a further implementation, an illumination device with light sources LQ, especially LEDs, is mounted in or on the rear wall 21 or the border strip 22. Due to the high luminosity of the aforementioned display design and with the help of available ambient light, the light sources LQ can be relatively low-powered, i.e. energy-saving.

The special configuration of the diffusion layer or diffusion screen, respectively 14, or retro-reflection layer or retro-reflection film, respectively, with fluorescent dyes also contributes to the increase in luminosity. As explained above, the use of the BEF polarization filter 13, thus, achieves the increase in luminosity, in that the polarization direction of the light reflected from the BEF filter 13 is changed. The use of fluorescent dyes 14.1 in the diffusion screen 14 or reflective film renders the change in the polarization direction especially efficient. The fluorescent dyes 14.1 cause the shorter-wavelength light to be absorbed and then continuously emitted in the emission wavelength of the fluorescent dyes 14.1, e.g. with consistent disbursement of the polarization direction. For simple application to a rear support layer, the retro-reflection film is coated with a self-adhesive layer on its rear side.

The diffusion layer or diffusion screen, respectively 14, or retro-reflection layer or retro-reflection film, respectively, with highly pure fluorescent dyes, forms an emissive color filter. In one design, it significantly contributes to enhanced readability and contrast under unfavorable outer illumination conditions as a semi-transparent (transflective) optical element (plate, film, sandwich, print, coating): in a monochrome implementation, e.g. as a solid-colored plastic plate, film, sandwich structure, or in polychrome implementation, e.g. as print, coating on a translucent polymer carrier. In so doing it yields an increase in energy efficiency through better utilization of a backlight during transmissive operation. In conjunction with this, a number of principal design variations arise, namely

a transparent or translucent thermoplastic polymer as a matrix, containing one or more photo-stable and thermally stable fluorescent dyes as well as a polymer or inorganic particulate optical diffuser. Alongside these, it can also contain commercial UV-stabilizers, dyes, or process aids. Typical matrix polymer classes that come into consideration here are, among others, polycarbonates, polyesters, poly(methyl) acrylate and its copolymers, polystyrene and polystyrene-copolymers, polyvinylchloride (PVC), polyvinyl fluoride (PVDF), cycloolefin copolymers well as their physical mixtures and blends. Particularly favored among these are polycarbonate (PC), polymethyl acrylate (PMMA), polyethylene terephthalate (PET), methylacrylate-acrylonitrile-butadiene-styrol copolymers (MABS), and polyvinylchloride (PVC).

Diffusion bodies and fluorescent dyes can be present together in one layer as well as in separate layers (in multi-layer designs). In the first case the diffusion body must be photo-inactive, i.e. it may not exhibit any photo-catalytic or photochemical activity. Barium sulfate, zinc sulfide, or zirconium oxide as well as all polymer diffusion materials, such as the Paraloid™ product line by Arkema (preferably barium sulfate and zinc sulfide or mixtures of them) are named as examples of photo-inactive diffusion bodies. Titanium dioxide as well as doped and undoped stannous oxide (preferably titanium dioxide) are named as examples of preferred photoactive diffusion bodies. Examples of preferred photo-stable and thermally stable fluorescent dyes are the Lumogen® F product line by BASF as well as the Hostasol ® product line by Clariant.

The fluorescent dyes are generally dosed so that the optical density has a maximum absorption range of 1.5 to 2. This produces an effective dosing level of 0.001 to 10% by weight, depending on the density of the colored layer and the absorption efficiency of the dye. Typically for thick through-colored systems (e.g. plates, sandwiches) >2 mm thick it is 0.001 to 0.1% by weight, while for thin, through-colored systems (films, sandwiches) <0.5 mm thick, it is 0.05 to 2% by weight, and for print or coating applications in the range of 0.5 to 10% by weight.

The particulate diffusion materials generally are dosed so that the average transmission values of the overall system lie outside of the absorption bands of the dye by approximately 50%. This produces an effective dosing level of 0.1 to 40% by weight, depending on the thickness of the additive-containing layer and the scattering efficiency of the diffusion body. For thick, whole-body-additive containing systems (e.g., plates, sandwiches) >2 mm thick this typically lies in the range of 0.1 to 5% by weight and for thin, whole-body-additive containing systems (films, sandwiches) <0.5 mm thick between 2 and 40% by weight. For print or coating applications, the attainable layer thickness (of a few micrometers), is generally not sufficient to produce the desired diffusion effect. In this case, the diffusion materials should be integrated completely, or at least predominantly, in the substrate that is to be imprinted or coated.

In the non-transparent, reflecting, optical implementation, which is advantageously used in the construction of highly legible displays without backlighting (reflective operation), different implementation variations likewise come into consideration. These variations are in the form of multilayer film, sandwich structure, print, or coating. In a monochrome implementation, e.g. a film that is dyed in the surface layer, a sandwich structure made of at least a through-colored, transparent layer, and an optional reflecting layer positioned behind the sandwich or a print come into consideration. In a polychromatic implementation, a print, a coating on a reflective polymer or metallic support come into consideration. A preferred implementation comprises a micro-prismatic sandwich film, as described in EP 0 853 646 or EP 0 862 599.

In an especially preferred design, the emissive color filter serves simultaneously as an assembly/LC glass support.

For example, in a first implementation, a green-yellow emissive color filter in plate format is used. In this implementation, the structure comprises a PMMA panel, which is single-layered (e.g. approximately 2-6 mm, e.g. 3-5 mm thick). It is implemented using 0.01 Lumogen F yellow 083 (BASF) and 2% Barium sulfate (Blanc Fixe; Sachtleben). Further implementation examples involve a construction analogous to example 1, however, using Lumogen F yellow 170 (BASF: yellow), Lumogen F orange 240 (BASF; orange), Lumogen F pink 285 (BASF; orange-red), Hostasol red GG (Clariant; s.o. 63; orange-red), Lumogen F red 305 (BASF; red) and/or Lumogen F green 850 (BASF; green).

In an additional implementation the use of an optical brightener instead of a fluorescent dye produces an emissive performance.

The combination of the three components, liquid crystal cell 12 operating in voltage-free light mode, BEF polarization filter as rear polarization filter 13, and a diffusion layer or diffusion screen, respectively 14, or retro-reflection layer or retro-reflection film, respectively, with fluorescent dyes, contributes advantageously to an especially effective increase in luminosity and also contrast. In this manner the luminosity of liquid crystal displays is considerably improved. Even with relatively little ambient light, clearly legible displays are attained even without additional backlighting.

1-9. (canceled)

10. A liquid crystal display having a multi-layer display unit, the liquid crystal display comprising, from front to rear:
a front polarization filter;
a liquid crystal layer;
a rear polarization filter;
one of a diffusion layer and retro-reflection layer; and
fluorescent dye associated with the one of a diffusion layer and retro-reflection layer.

11. The liquid crystal display of claim 10, wherein the liquid crystal layer is of a voltage-free light type.

12. The liquid crystal display of claim 10, wherein the rear polarization filter comprises a luminosity enhancing film.

13. The liquid crystal display of claim 10, further comprising a back light assembly behind the diffusion layer.

14. The liquid crystal display of claim 10 further comprising a housing supporting the multi-layer display unit, said housing having a light-transmissive rear wall.

15. The liquid crystal display of claim 14, wherein the housing has light-transmissive side walls.

16. (canceled)

17. The liquid crystal display of claim 15, further comprising at least one light source mounted with respect to at least one of the housing rear and side walls.

18-19. (canceled)

20. A liquid crystal display comprising:
front and rear polarization filters;
a liquid crystal layer between the polarization filters;
one of a diffusion layer and a retro-reflection layer behind the rear polarization filter; and
at least one fluorescent dye associated with the one of a diffusion layer and retro-reflection layer.

21. The liquid crystal display of claim 20 wherein the one of a diffusion layer and a retro-reflection layer comprises a matrix and the matrix includes the at least one fluorescent dye associated therewith.

22. The liquid crystal display of claim 21 wherein the matrix further includes at least one of a polymer or inorganic particulate optical diffuser, a UV-stabilizer, a dye or a process aid associated therewith.

23. The liquid crystal display of claim 21, wherein the matrix is a thermoplastic polymer matrix comprising one or more of polycarbonates, polyesters, poly(methyl) acrylates, poly(methyl) acrylate copolymers, polystyrenes, polystyrene copolymers, polyvinylchloride, polyvinyl fluoride, cycloolefin copolymers and mixtures thereof.

24. The liquid crystal display of claim 20, wherein the at least one fluorescent dye comprises plural dyes.

25. The liquid crystal display of claim 20, wherein the at least one fluorescent dye comprises one or more of fluorescent yellow dye, fluorescent orange dye, fluorescent pink dye, fluorescent red dye, fluorescent green dye and mixtures thereof.

26. The liquid crystal display of claim 20, wherein the at least one fluorescent dye is present in an amount sufficient to provide an optical density with an absorption maximum in the range of about 1.5 to 2.

27. The liquid crystal display of claim 20, wherein the at least one fluorescent dye is present in the one of a diffusion layer and a retro-reflection layer in an amount of about 0.001 to 10% by weight.

28. The liquid crystal display of claim 20, wherein the one of a diffusion layer and a retro-reflection layer further includes diffusion bodies.

29. The liquid crystal display of claim 28, wherein the diffusion bodies comprise at least one of photo inactive and photo active diffusion bodies.

30. The liquid crystal display of claim 29, wherein the photo inactive diffusion bodies comprise one or more of barium sulfate, zinc sulfide, zirconium oxide and polymer diffusion materials.

31. The liquid crystal display of claim 29, wherein the photo active diffusion bodies comprise one or more of titanium dioxide, doped tin oxide and undoped tin oxide.

32. The liquid crystal display of claim 20, wherein the liquid crystal layer is of a voltage-free light type.

33. The liquid crystal display of claim 32, wherein the liquid crystal layer comprises one of a twisted nematic and a low twisted nematic layer.

34. The liquid crystal display of claim 20, wherein the rear polarization filter comprises a brightness enhancing film.

35. The liquid crystal display of claim 20, further comprising a back light assembly behind the one of a diffusion layer and a retro-reflection layer diffusion layer.

36. The liquid crystal display of claim 20, further comprising a housing supporting the liquid crystal display.

37. The liquid crystal display of claim 36, wherein the housing has at least one light-transmissive surface.

38-39. (canceled)
